(19) United States
(12) Patent Application Publication
(10) Pub. No.: US 2004/0124144 A1
(43) Pub. Date: Jul. 1, 2004

(54) Process for the purification of N-carboxyanhydrides of amino acids

(76) Inventors: Antoine Paris, Rouen (FR); Marc Lebon, Ormoy La Riviere (FR)

Correspondence Address: MUSERLIAN AND LUCAS AND MERCANTI, LLP, 475 PARK AVENUE SOUTH, NEW YORK, NY, 10016, US

(21) Appl. No.: 10/689,968

(22) Filed: Oct. 21, 2003

(30) Foreign Application Priority Data
Oct. 29, 2002 (FR) 02 13498

(51) Int. Cl. B01D 15/00

(52) U.S. Cl. 210/638; 210/639; 210/679

(57) ABSTRACT

The invention relates to a process for the purification of N-carboxyanhydrides of amino acids which is characterized in that the N-carboxyanhydrides, in solution or in suspension in a nonpolar solvent medium, are brought into contact with silica.

Furthermore, it is possible to further improve the purification by treating the N-carboxyanhydrides with an aqueous solution of an inorganic or organic acid.

The N-carboxyanhydrides thus treated are no longer coloured.

The invention relates to a process for the purification of N-carboxyanhydrides of amino acids.

The N-carboxyanhydrides (abbreviation NCA) derived from amino acids, in particular α-, β- or γ-amino acids, are very useful intermediates because of the activation of the acid functional group and the protection of the amine functional group which they exhibit. In fact, they allow the reaction of this acid functional group with any nucleophilic entity. Thus, the formation of the amide functional group by reaction with an amine functional group is facilitated. For this reason, they are readily polymerized and are used to form peptides. The ester bond by reaction with an alcohol is also readily created. They are also advantageous when it is desired to reduce an acid functional group. Their characteristics are more particularly described in the reference work: “α-Amino Acid N-Carboxyanhydrides and Related Heterocycles” by H. R. Kricheldorf, 1987, Springer-Verlag.

For the majority of their applications, they have to be very pure, in particular colourless, devoid of undesired stereoisomer and freed from unreacted starting compounds and reaction byproducts.

Conventional purification processes, such as recrystallization or decolouration in the presence of active charcoal, are not satisfactory. The technique of passing the compounds through a packed column is a laboratory technique which cannot be used industrially. It requires very large amounts of packing material and large amounts of specific eluents, which have to be chosen according to the rates of elution of the impurities and of the product to be recovered, as well as close monitoring. These large amounts of eluents and of packing materials subsequently have to be eliminated.

The N-carboxyanhydrides which readily polymerize are also highly sensitive to hydrolysis. Because of these characteristics, a subsequent purification treatment after they have been formed presents problems.

There consequently existed a need to find a process for the treatment of N-carboxyanhydrides which can be used on an industrial scale and which makes it possible to obtain them without coloration, purer and with a very good yield.

The process for the purification of N-carboxyanhydrides according to the present invention is characterized in that the N-carboxyanhydride(s) of amino acids to be purified, in solution or in suspension in a nonpolar solvent medium, is/are brought into contact with silica added to the medium or constituting a stationary bed.

On conclusion of this treatment, the colouring of the N-carboxyanhydrides has virtually disappeared. They have not been decomposed. Their purity is improved. Optically active compounds have not undergone racemization. Polymers have not been formed. The latter result is surprising since silica is generally known to promote the polymerization of N-carboxyanhydrides. The yield is excellent, often greater than 99%.

Furthermore, it has been found that the purification can be further improved by subjecting the N-carboxyanhydrides, purified as indicated above by means of silica, to a treatment with an inorganic or organic acid.

This process makes it possible to remove the traces of organic or inorganic materials still remaining in the N-carboxyanhydrides.

The N-carboxyanhydrides which are purified by the process of the present invention are all the N-carboxyanhydrides of natural or synthetic amino acids. They are generally represented by the formula

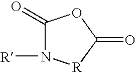

in which R represents the central radical between the acid functional group and the amine functional group of the amino acid, which is optionally modified, and R′ represents a hydrogen atom or the radical carried at the beginning by the nitrogen atom of the amino acid or which has been subsequently attached or modified and which can be bonded to R, in particular when the amino acids are cyclic.

In particular, these are N-carboxyanhydrides of α-, β- or γ-amino acids and more particularly of α-amino acids.

The reactive groups present in the compounds are in the protected or unprotected form, as is usual.

The N-carboxyanhydrides can be in their various forms and in particular, when they possess one or more asymmetric carbons, in their various stereochemical forms, such as racemates, enantiomers or diastereoisomers. The purification process according to the invention does not bring about racemization and the stereoisomers with the same configuration as the starting configuration can be obtained.

The process is particularly well suited to the purification of compounds such as those disclosed in French Patent Application No. 2 815 962 or the U.S. Pat. No. 6,479,665.

According to the process of the invention, the N-carboxyanhydrides to be purified must be brought into contact with silica.

To promote contact between the N-carboxyanhydrides and the silica, the purification takes place by means of a medium which is a solvent for the N-carboxyanhydrides and which is nonpolar. Aromatic hydrocarbons are highly suitable as nonpolar solvents, in particular toluene or xylene.

The N-carboxyanhydrides can be completely dissolved in the solvent medium or can form a suspension in the latter. Generally, it is preferable for them to be largely dissolved and the choice of the solvent will depend on the N-carboxyanhydride(s) to be purified.

It has also been found that the contacting operation had to be carried out by addition of the silica to the medium comprising the N-carboxyanhydrides to be purified or by putting the silica into the form of a stationary bed.

According to the process of the invention, very low amounts of silica can be used, such as 0.5 to 10% by weight (limits included) with respect to the weight of N-carboxyanhydride(s) to be purified.

When the silica constitutes a stationary bed, it can be placed at the outlet of the reactor and the mixture formed by the N-carboxyanhdyride(s) then passes into the stationary bed.

According to the preferred alternative form of the process, the mixture of the N-carboxyanhydride(s), of the silica and of the solvent medium can be produced simply by, for example, stirring it.

Use is preferably made, as silica, of the silicas belonging to the category known under the name silica gel, for example such as those used conventionally for chromatography,

As is known, N-carboxyanhydrides are very sensitive to hydrolysis. For this reason, the treatment is preferably carried out under an anhydrous atmosphere, for example under a nitrogen atmosphere.

The duration of the contact and the amounts of silica and of solvent used depend on the N-carboxyanhydrides, on the extent of the colouration to be removed and on the method of contact used.

If necessary, the mixture can be heated to a temperature at which the N-carboxyanhydrides are not decomposed.

Amounts of silica of less than 5%, ambient temperature and a contact time of one to a few hours are generally sufficient when the choice is made to add the silica to the mixture.

On completion of the treatment, the N-carboxyanhydrides are recovered according to conventional methods. In particular, after having separated the silica from the mixture, the N-carboxyanhydrides are precipitated by removing the solvent or by adding a liquid which is not a solvent for the N-carboxyanhydrides, optionally after having removed a portion of the solvent, for example by distillation. Mention may be made, as precipitation liquid, of alkanes, such as heptane or cyclohexane, or ethers, such as tert-butyl methyl ether or diisopropyl ether.

It is found that the N-carboxyanhydrides recovered are no longer coloured and are generally solids which are white in colour. The analyses show that the purity of the compounds increases and that there has been no racemization of optical isomers. The yields are good, often of the order of 99%.

To further improve these results, if necessary, it is possible, after having treated the N-carboxyanhdyrides with silica, to bring them into contact one or more times with an aqueous solution of an inorganic or organic acid.

This treatment is preferably carried out at a pH of 1 to 2.

Mention may be made, as acids, of inorganic acids, such as hydrochloric acid or sulphuric acid, and organic acids, such as acetic acid or citric acid.

The concentration of the acid in the aqueous solution is preferably between 0.5% w/w and 5% w/w, more particularly between 0.5% w/w and 1.5% w/w.

Use is preferably made of an inorganic acid and more particularly of hydrochloric acid.

It is preferable to carry out the treatment at a low temperature of between 0° C. and 15° C. and preferably between 0° C. and 5° C.

The acid solution is generally mixed with the solution or the suspension of N-carboxyanhydrides after having extracted the silica therefrom. The solvent medium can optionally be changed before the treatment. On completion of the treatment, aqueous phases are removed, for example by separating by settling or by azeotropic distillation with the solvent.

The purified N-carboxyanhydrides are recovered as indicated above in a known way. This additional treatment makes it possible to improve the chemical purity of the N-carboxyanhydrides by more exhaustive removal of traces of contaminants.

This result is surprising as it might have been feared that the N-carboxyanhydrides would be hydrolyzed and that, consequently, they would comprise much more impurities.

The examples which follow illustrate the invention without, however, limiting it.

### EXAMPLE 1

600 ml of toluene and 150 g (0.491 mol) of N-[1-(S)-ethoxycarbonyl-3-phenylpropyl]-L-alanine-N-carboxyanhydride (abbreviation: EPAL-NCA), with a greyish, slightly pinkish, colour, are introduced into an equipped and stirred 1 litre reactor under a stream of nitrogen. 1.5 g of silica gel (70-200 μm) of the Millipore trademark are subsequently introduced and the mixture is stirred for approximately 1 hour.

The mixture is filtered and the silica is rinsed with toluene. The pale-yellow filtrate collected is then concentrated by distillation under reduced pressure.

Heptane B is subsequently added to the medium. A precipitate is formed. The medium is cooled to completely precipitate the EPAL-NCA.

The suspension is filtered and the solid is rinsed with heptane B. The wet white cake is subsequently dried in an oven under vacuum.

148.7 g (yield 99.1%) of purified EPAL-NCA, a white solid, are then collected.

The characteristics of the starting EPAL-NCA and of the EPAL-NCA obtained after purification are collated in the following table:

| Characteristics | Starting EPAL-NCA | Purified EPAL-NCA |
|---|---|---|
| Appearance | Slightly pinkish, | White solid |
| | grey solid | |
| Optical rotation | +12.3° | +12.4° |
| [α]_{D}²⁵ (c = 2, | | |
| CH₃CN) | | |
| Purity by HPLC | 99.80% | 99.90% |

### EXAMPLE 2

200 g of EPAL-NCA in 800 ml of toluene are treated with 2.0 g of silica gel (40-70 μm) as in Example 1.

The mixture is filtered to separate the silica and the silica is rinsed with toluene.

The filtrate is twice mixed, with stirring, with 200 ml of a 1% (w/w) aqueous hydrochloric acid solution, the pH of which is approximately 1.5, at a temperature of 0°-5° C. and the aqueous phase is removed on each occasion.

The EPAL-NCA is subsequently recovered by carrying out the operation as in Example 1, after concentrating the medium and using heptane B.

185.6 g of dry solid EPAL-NCA (yield 92.8%) which is white in colour are obtained. Its starting characteristics and characteristics after purification are collated in the following table:

| Characteristics | Starting EPAL-NCA | Purified EPAL-NCA |
|---|---|---|
| Appearance | Grey solid | White solid |
| Optical rotation | +12.2° | +12.4° |
| [α]_{D}²⁵ (c = 2, | | |
| CH₃CN) | | |
| Purity by HPLC | 99.85% | 99.83% |

### EXAMPLE 3

200 g of EPAL-NCA, comprising 0.5% of EPAL, are treated in 800 ml of toluene with 2.0 g of silica gel (40-70 μm) as in Example 2.

The mixture is filtered to separate the silica and the silica is rinsed with toluene.

The filtrate is washed twice with a 1% (w/w) hydrochloric acid solution as in Example 2.

The EPAL-NCA is subsequently recovered by carrying out the operation as in Example 1, after concentrating the medium and using heptane B.

184 g of dry solid EPAL-NCA (yield 92%) which is white in colour are obtained. Its starting characteristics and characteristics after purification are collated in the following table:

| Characteristics | Starting EPAL-NCA | Purified EPAL-NCA |
|---|---|---|
| Appearance | Grey solid | White solid |
| Purity by HPLC | 99.5% | |

1. Process for the purification of N-carboxyanhydrides of amino acids, characterized in that the N-carboxyanhydride(s) of amino acids, in solution or in suspension in a nonpolar solvent medium, is/are brought into contact with silica added to the medium or constituting a stationary bed.

2. Process according to claim 1, characterized in that the amount of silica used is chosen within the range from 0.5 to 10% by weight with respect to the weight of N-carboxyanhydrides to be purified.

3. Process according to claim 1 or 2, characterized in that contact is achieved by mixing, in the nonpolar solvent medium, the silica with the N-carboxyanhydride(s), in solution or in suspension.

4. Process according to any one of the preceding claims, characterized in that the silica used is chosen within the category known as silica gel

5. Process according to any one of the preceding claims, characterized that the solvent medium is chosen from aromatic hydrocarbons.

6. Process according to any one of the preceding claims, characterized in that the purified N-carboxyanhdyride(s) is/are treated with an aqueous solution of an inorganic or organic acid.

7. Process according to claim 5, characterized in that the pH of the medium during the treatment is between 1 and 2.

8. Process according to claim 5 or 6, characterized in that the treatment is carried out at a temperature of between 0° C. and 15° C.

9. Process according to any one of claims 5 to 7, characterized in that the acid used is an inorganic acid.

10. Process according to the preceding claim, characterized in that the inorganic acid is hydrochloric acid.
